(19) United States
(12) Patent Application Publication
(10) Pub. No.: US 2021/0120802 A1
(43) Pub. Date: Apr. 29, 2021

(54) QUICK CLEANING STRUCTURE AND MOSQUITO-KILLING LAMP

(71) Applicant: FOSHAN OSA ELECTRICAL CO., LTD, Foshan (CN)

(72) Inventor: Jianxin He, Foshan (CN)

(21) Appl. No.: 16/746,859

(22) Filed: Jan. 18, 2020

(30) Foreign Application Priority Data
Oct. 23, 2019 (CN) 201921782604.0

(51) Int. Cl. A01M 1/22; B08B 1/00; A01M 1/04

(52) U.S. Cl. CPC A01M 1/223; A01M 2200/012; A01M 1/04; B08B 1/005

(57) ABSTRACT

A quick cleaning structure and a mosquito-killing lamp applying the same, the quick cleaning structure includes a lamp holder and a high-voltage support, the high-voltage support includes a plurality of high-voltage tubes and a sliding cleaning member provided with a plurality of sliding through-holes, at least one ends of the high-voltage tubes are fixedly mounted on the lamp holder and are disposed in parallel with each other, each high-voltage tube passes through the sliding through-hole provided at a corresponding position, the sliding cleaning member slides along an outer wall of the high-voltage tubes. The sliding cleaning member of the quick cleaning structure slides along the high-voltage tubes under an external force, and the sliding through-holes provided in the sliding cleaning member are in contact with the outer wall of the high-voltage tubes to clear mosquito bodies adhered on the outer wall of the high-voltage tubes.

### CROSS REFERENCE TO RELATED APPLICATIONS

The present application is based on Chinese patent application No. 201921782604.0 filed on Oct. 23, 2019 and claims its priority. The entire disclosure of the application is hereby incorporated by reference in its entirety.

### TECHNICAL FIELD

The present application relates to mosquito-killing lamps, in particular to a quick cleaning structure and a mosquito-killing lamp applying the same.

### BACKGROUND

A mosquito-killing lamp is a simple and practical mechanical device that traps mosquitoes through a negative pressure device after attracting the mosquitoes with light or chemicals according to the living habits of mosquitoes. It is a new generation of efficient and environment-friendly device for killing mosquitoes.

The basic structure of the mosquito-killing lamp includes an ultraviolet fluorescent tube, a high-voltage net, printed circuit boards (mainly containing double voltage rectifier circuits) and a fence-like plastic casing. The ultraviolet fluorescent tube is at the center inside the plastic casing, and is surrounded by a high-voltage net. The existing electric shock mosquito-killing lamps include a lamp tube, a high-voltage shock net and a base frame. It is characterized in that the base frame includes a top plate, a bottom plate and two side plates. Both ends of the lamp are respectively arranged on the two side plates. The high-voltage electric shock net is installed on the two side plates and covers a front side, an upper side and a lower side of the lamp tube. A mosquito storage box is arranged on the bottom plate of the base frame and located under the high-voltage electric shock net. A front protective net and a rear protective net are respectively disposed at a front and rear part of the base frame, and a gap is provided between a lower end of the front protective net and the bottom plate. The lower end of the front protective net is bent to form a wing net. The wing net covers the lower part of the high-voltage electric shock net in cooperation with the rear protective net, and a gap is provided between the wing net and the bottom plate. When a mosquito is attracted by the light and flies toward the lamp tube, it will be shocked by the high-voltage electric shock net thereby achieving the purpose of mosquito killing.

However, the existing electric shock mosquito lamp has the difficulties in cleaning, specifically, when mosquitoes are killed by the high-voltage electric shock net, the mosquito bodies are trapped on the high-voltage electric shock net or even on an outer wall of the lamp tube near the high-voltage electric shock net. In addition, the high-voltage electric shock net and the outer wall of the lamp tube are prone to accumulate debris after long-term use. When the high-voltage electric shock net and the outer wall of the lamp tube are contaminated with debris, the shocking effect of the high-voltage electric shock net to mosquito will be directly influenced, and the light transmission of the lamp tube will decrease lowering its effect of attracting mosquitoes, so that the mosquito killing effect of the electric shock mosquito-killing lamp is greatly reduced.

### SUMMARY OF THE APPLICATION

In view of the above drawbacks, an objective of the present application is to provide a quick cleaning structure and a mosquito-killing lamp using the same. The quick cleaning structure can quickly clean the mosquito-killing lamp, thereby ensuring the mosquito killing effect of the mosquito-killing lamp.

To this end, the present application adopts the following technical proposals,

A quick cleaning structure includes: a lamp holder and a high-voltage support; the high-voltage support includes a sliding cleaning member and a plurality of high-voltage tubes; the sliding cleaning member is provided with a plurality of sliding through-holes; at least one end of each of the high-voltage tubes is mounted and fixed to the lamp holder, and the plurality of high-voltage tubes are disposed in parallel with each other between a bottom part and a top part of the lamp holder; each of the high-voltage tubes passes through the sliding through-hole provided at a corresponding position. The sliding cleaning member is slidable along an outer wall of the high-voltage tubes under an external force.

Further, a shape of the sliding through-holes is the same as a shape of an outline of the outer wall of the high-voltage tubes, and each of the sliding through-holes is provided with an annular recessed portion on an upper surface side of the sliding cleaning member.

Further, the plurality of high-voltage tubes are arranged in a ring shape at equal spacing; the sliding through-holes are annularly distributed on the sliding cleaning member, and each of the sliding through-holes is respectively sleeved on the outer wall of the high-voltage tubes at a corresponding position.

Further, the high-voltage support further includes: a pull rod provided with a travel limiting portion; the bottom part or the top part of the lamp holder is provided with a drawing sliding hole; the pull rod is arranged in parallel with the high-voltage tubes; an end of the pull rod is connected to the sliding cleaning member, and the other end extends outside the lamp holder through the drawing sliding hole, the travel limiting portion is stopped at the drawing sliding hole and is limited at an inside of the lamp holder.

Further, an end of the pull rod is provided with a flexible snap portion; the sliding cleaning member is provided with a snap ring portion engagable with the flexible snap portion; the flexible snap portion passes through the snap ring portion and is engaged with the snap ring portion.

Further, the number of the pull rods is at least two; the number of the snap ring portions is equal to the number of the pull rods, and a plurality of snap ring portions are disposed symmetrically with respect to a geometric center of the sliding cleaning member; an end of each of the plurality of pull rods is connected and fixed to an operating portion outside the lamp holder.

Further, the high-voltage support also has a fixing member made of an insulating material; an end of each of the plurality of high-voltage tubes is fixed to the lamp holder, and the other end is fixed to the fixing member.

A mosquito-killing lamp applying the quick cleaning structure as described above includes: the quick cleaning structure, a circuit board and a lamp tube; the circuit board is disposed on the lamp holder and is electrically connected to both of the high-voltage tubes and the lamp tube; at least one end of the lamp tube is fixedly mounted to the lamp holder, the lamp tube is disposed in parallel with the high-voltage tubes and is located inside the high-voltage support.

Further, a central part of the sliding cleaning member is provided with a central cleaning hole, and the central cleaning hole is sleeved on an outer wall of the lamp tube and slides along the outer wall of the lamp tube; an annular surface of the central cleaning hole in contact with the outer wall of the lamp tube is provided with a rubber layer.

Further, a protective net cover is arranged on the lamp holder, the protective net cover has a hollow mesh region, and the protective net cover covers the high-voltage support.

The present application provides a quick cleaning structure and a mosquito-killing lamp applying the same. The sliding cleaning member provided in the quick cleaning structure slides along the high-voltage tubes under an external force, and the sliding through-holes provided on the sliding cleaning member is in contact with the outer wall of the high-voltage tubes, so that the mosquito bodies and the like adhered on the outer wall of the high-voltage tubes are cleared, thus the mosquito-killing lamp applying the quick cleaning structure has a function of quickly and easily cleaning the debris, and the effect of the mosquito-killing lamp is guaranteed, together with a longer service life.

### BRIEF DESCRIPTION OF THE DRAWINGS

FIG. 1 is a perspective structural view of an embodiment of the present application;

FIG. 2 is an exploded structural view of the embodiment shown in FIG. 1;

FIG. 3 is another exploded structural view of the embodiment shown in FIG. 1;

FIG. 4 is yet another exploded structural view of the embodiment shown in FIG. 1;

FIG. 5 is a structural view of a partial structure of an embodiment of the present application;

FIG. 6 is a structural view of a partial structure of an embodiment of the present application;

FIG. 7 is a sectional structural view of a sliding cleaning member of an embodiment of the present application;

FIG. 8 is a structural view of a partial structure of an embodiment of the present application.

Lamp holder 100, top part 110, bottom part 120, protective net cover 130, drawing sliding hole 140, high-voltage support 200, high-voltage tube 210, sliding cleaning member 220, sliding through-hole 221, annular recessed portion 222, snap ring portion 223, central cleaning hole 224, rubber layer 225, pull rod 230, travel limiting portion 231, flexible snap portion 232, operating portion 233, fixing member 240, lamp tube 300.

### DESCRIPTION OF THE EMBODIMENTS

The technical proposal of the present application will be further described below with reference to the accompanying drawings and specific embodiments.

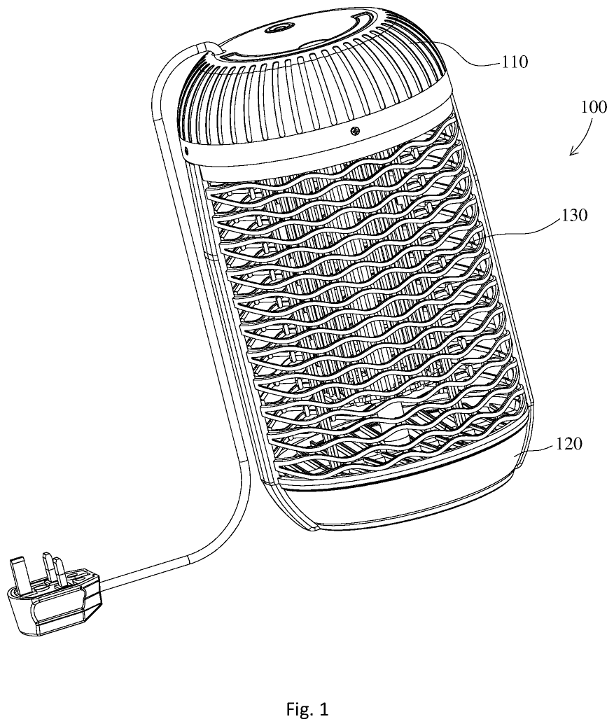

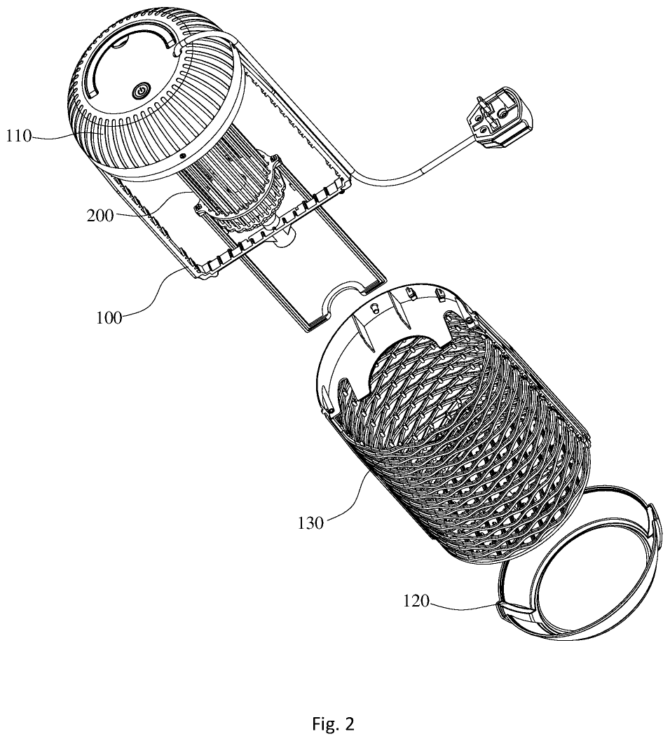

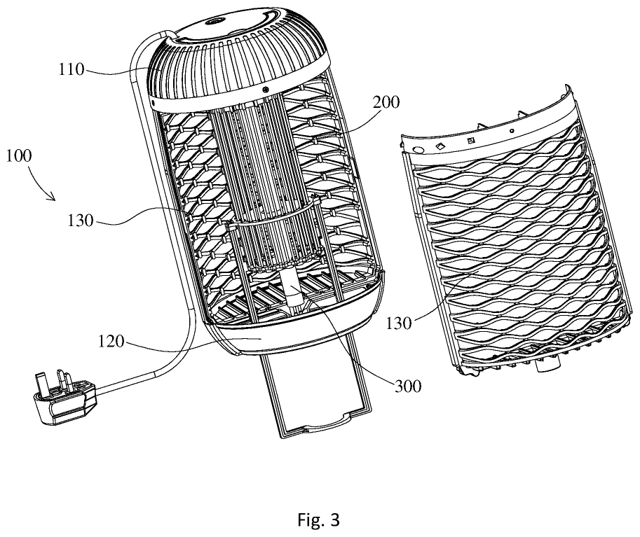

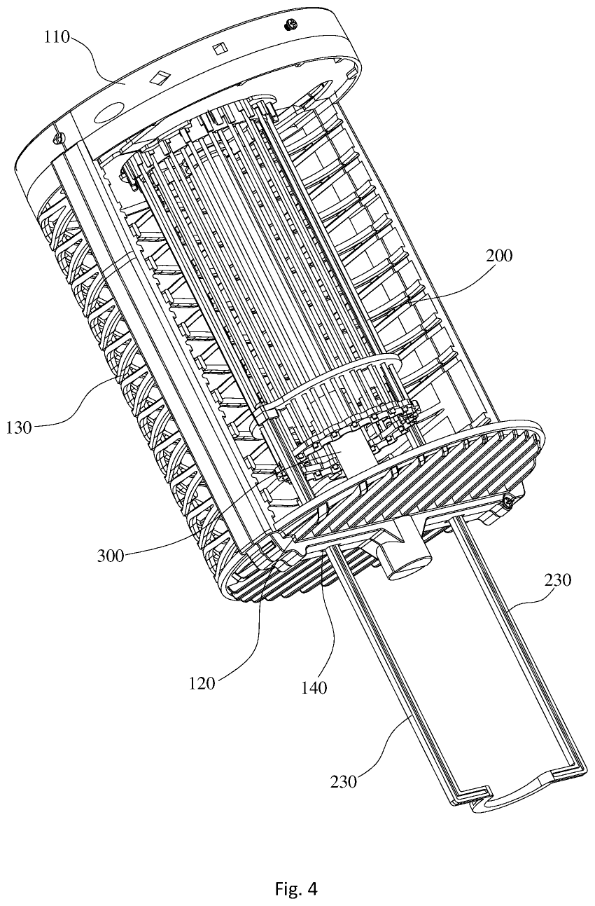

As shown in FIGS. 1-8, a quick cleaning structure includes: a lamp holder 100 and a high-voltage support 200. The high-voltage support 200 includes: a sliding cleaning member 220 and a plurality of high-voltage tubes 210. The sliding cleaning member 220 is provided with a plurality of sliding through-holes 221. At least one end of the high-voltage tube 210 is fixedly mounted on the lamp holder 100, and a plurality of high-voltage tubes 210 are disposed in parallel with each other between the bottom part 120 and the top part 110 of the lamp holder 100. Each of the high-voltage tubes 210 passes through a sliding through-hole 221 provided at a corresponding position, and the sliding cleaning member 220 is slidable along outer walls of the high-voltage tubes 210 under an external force.

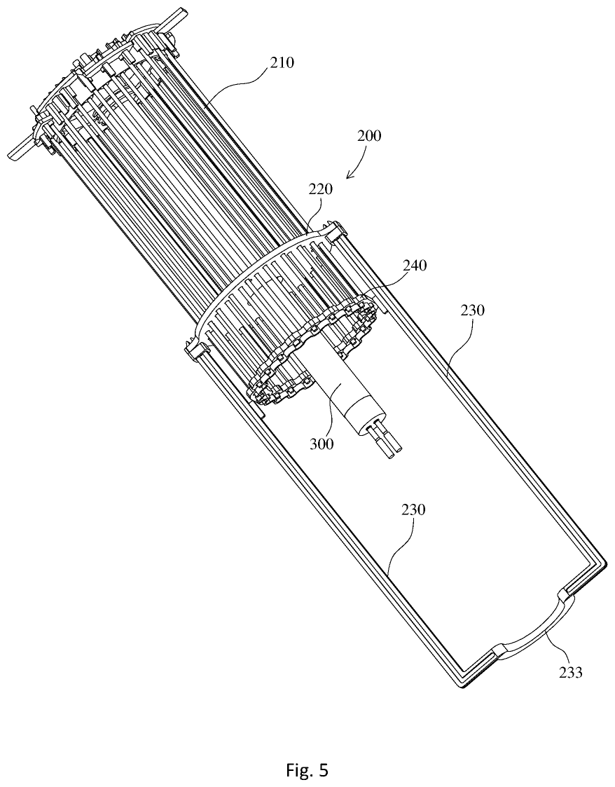

As shown in FIGS. 5-8, the sliding through-hole 221 each has a same shape as the shape of an outline of the outer wall of the high-voltage tubes 210, and each of the sliding through-holes 221 is provided with an annular recessed portion 222 on an upper surface side of the sliding cleaning member 220. The annular recessed portions 222 are provided on the upper surface of the sliding cleaning member 220 because, on the one hand, since several points on the sliding cleaning member 220 are subject to a reaction force during sliding, the sliding cleaning member 220 must have enough thickness to ensure its strength, however, the width of the contact area between the sliding through-holes 221 and the outer walls of the high-voltage tubes 210 increases with the thickness of the sliding cleaning member 220, which will hinder the sliding, addition of the annular recessed portion can reduce the width of an inner annular surface of the sliding through-holes 221, so that the contact area between the sliding through-holes 221 and the outer walls of the high-voltage tubes 210 becomes smaller, which facilitates sliding of the sliding cleaning member 220 and is not easy to be stuck. On the other hand, when the annular recessed portions 222 are provided on the upper surface of the sliding cleaning member 220, the sliding direction of the quick cleaning structure during the cleaning process is preferably from the top part 110 to the bottom part 120 of the lamp holder 100, in this case, the annular recessed portions 222 will not be in contact with the debris, and the debris will not accumulate in the annular recessed portions 222, there is no complicated contacting structure on a lower surface of the sliding cleaning member 220, which makes the debris more easily drop from the sliding cleaning member 220.

The plurality of high-voltage tubes 210 are aligned in a ring shape at equal spacing; the sliding through-holes 221 are distributed in a ring shape on the sliding cleaning member 220, and each of the sliding through-holes 221 is sleeved on an outer wall of the high-voltage tube 210 arranged at a corresponding position. The high-voltage tubes 210 are aligned in the ring shape, so that the mosquito passes near the high-voltage tubes 210 on its way attracted by the light, thereby greatly increase the possibility that the mosquito is shocked by the high-voltage tubes 210.

The high-voltage support 200 further includes: a pull rod 230 arranged with a travel limiting portion 231; the bottom part 120 or the top part 110 of the lamp holder 100 is provided with drawing sliding holes 140. The pull rod 230 is disposed in parallel with the high-voltage tubes 210. One end of the pull rod 230 is connected to the sliding cleaning member 220, and the other end extends to an outside of the lamp holder 100 passing through the drawing sliding hole 140. The travel limiting portion 231 cannot pass through the drawing sliding hole 140, thus is limited to an inside of the lamp holder 100. The pull rod 230 enables a user to drive the sliding cleaning member 220 to slide. The travel limiting portion 231 is stopped by the corresponding structure inside the lamp holder 100, so that the sliding distance of the sliding cleaning member 220 can be effectively controlled. Therefore, the sliding cleaning member 220 can be prevented from sliding freely under an external force which may cause damage to the internal structure of the mosquito-killing lamp.

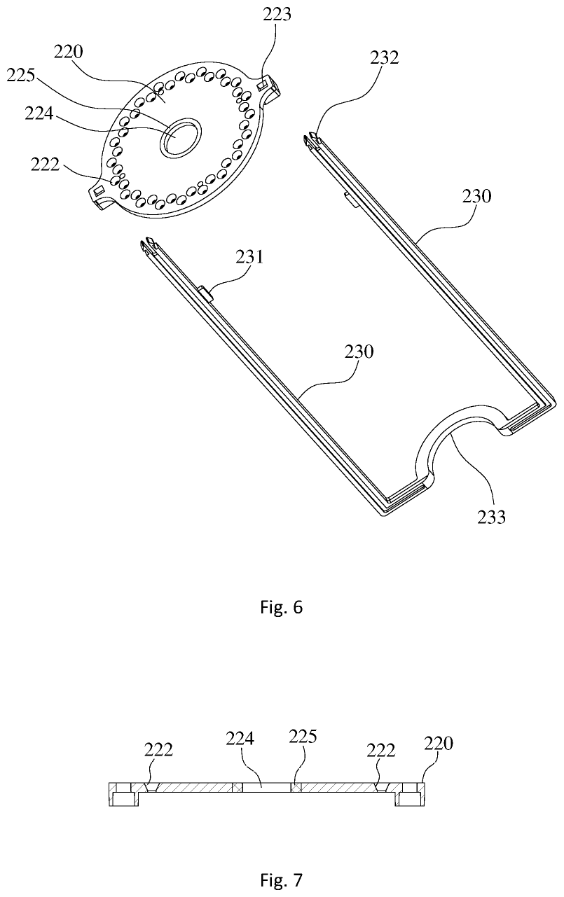

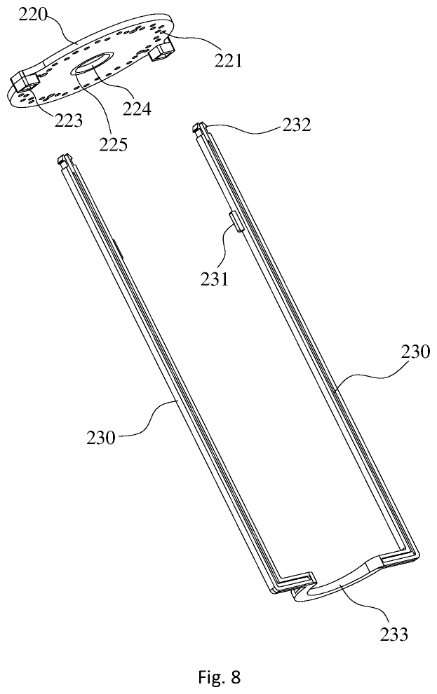

As shown in FIGS. 6 and 8, one end of each of the pull rods 230 is provided with a flexible snap portion 232, and the sliding cleaning member 220 is provided with snap ring portions 223 engagable with the flexible snap portions 232. The flexible snap portions 232 pass through the snap ring portions 223 and are engaged with the snap ring portions 223. The sliding cleaning member 220 and the pull rods 230 are connected by a detachable quick snap-fitting structure. On the one hand, it is convenient for the sliding cleaning member 220 and the pull rods 230 to be assembled, connected, repaired and replaced; on the other hand, the sliding cleaning member 220 and the pull rods 230 can be produced fast and separately in batches, hence the manufacturing difficulty and cost are reduced.

The number of the pull rods 230 is two; the number of the snap ring portions 223 is equal to the number of the pull rods 230, and the plurality of snap ring portions 223 are symmetrically disposed with respect to the geometric center of the sliding cleaning member 220; the one end of the two pull rods 230 is connected and fixed to an operating portion 233 outside the lamp holder 100. Since the mosquito-killing lamp is provided with more than one high-voltage tubes 210, the plurality of high-voltage tubes 210 will result in sliding resistance on the sliding cleaning member 220 at several different positions. In order to make the sliding cleaning member 220 subject to a reasonable amount of external force, and to avoid localized excessive force, at the same time, in order to ensure that the sliding cleaning member 220 slides perpendicularly with respect to the high-voltage tubes 210 to reduce the sliding resistance, a plurality of pull rods 230 are provided in a symmetric manner on the sliding cleaning member 220, and the pull rods 230 are connected together at one end thereof.

The high-voltage support 200 is further provided with a fixing member 240 which is made of an insulating material; one end of the plurality of high-voltage tubes 210 is fixed to the lamp holder 100, and the other end is fixed to the fixing member 240. In the mosquito-killing lamp, only one end of the high-voltage tubes 210 is connected and fixed to the top part 110 of the lamp holder 100, and if the other end of the high-voltage tubes 210 is not fixed, a short circuit or the like is likely to occur due to conductivity on contact. Therefore, the high-voltage support 200 is further provided with the fixing member 240 at the lower ends of the high-voltage tubes 210 to ensure the structural stability of the mosquito-killing lamp. The fixing member 240 is provided with a corresponding number of fixing holes to enable a quick install and fixing of the high-voltage tubes 210, and to ensure equal spacing between the high-voltage tubes 210, thus no wire contact occurs between the lower ends of the high-voltage tubes 210.

As shown in FIGS. 1-5, a mosquito-killing lamp applying the quick cleaning structure described above includes: the quick cleaning structure, a circuit board and a lamp tube 300. The circuit board is disposed on the lamp holder 100, and is electrically connected to the high-voltage tubes 210 and the lamp tube 300. The high-voltage tubes 210 are supplied with power, and the lamp tube 300 is used for illuminating. At least one end of the lamp tube 300 is fixedly mounted to the lamp holder 100. The lamp tube 300 is parallel to the high-voltage tubes 210 and is located inside the high-voltage support 200.

Referring to FIGS. 6-8, the central part of the sliding cleaning member 220 is provided with a central cleaning hole 224. The central cleaning hole 224 is sleeved on and slides along an outer wall of the lamp tube 300. An annular surface of the central cleaning hole 224 which is in contact with the outer wall of the lamp tube 300 is provided with a rubber layer 225. In addition to quickly cleaning the outer walls of the high-voltage tubes 210, the sliding cleaning member 220 can also clean the outer wall of the lamp tube 300 by using the cleaning hole. Moreover, the rubber layer 225 can prevent the glass outer wall of the lamp tube 300 from damages while cleaning the outer wall.

A protective net cover 130 is arranged on the lamp holder 100, the protective net cover 130 has a hollow mesh region, and the protective net cover 130 covers the high-voltage support 200. Due to the high voltage of the high-voltage support 200, the protective net cover 130 can prevent direct contact with the user, so that a safety use of the mosquito-killing lamp can be ensured. On the other hand, while ensuring the mosquitoes are attracted by the light and fly into the lamp holder 100, the hollow mesh region provided on the protective net cover 130 also has decorative function, so that the mosquito-killing lamp possesses a better integrity.

The mechanism of the quick cleaning structure is that the sliding cleaning member 220 is located at the top part 110 of the lamp holder 100, and is provided with holes slidable along the outer wall of each of the high-voltage tubes 210 and the lamp tube 300, respectively. After the outer wall of the high-voltage tubes 210 or the lamp tube 300 of the mosquito-killing lamp is adhered with debris such as mosquito bodies, the user can pull the pull rod 230 toward the bottom part 120 of the lamp holder 100 according to a specific position of the pull rod 230, so that the sliding cleaning member 220 slides from the top part 110 to the bottom part 120 of the lamp holder 100 along the high-voltage tubes 210 or the lamp tube 300. During the sliding process, the holes provided on the sliding cleaning member 220 removes the debris adhered on the outer wall of the high-voltage tubes 210 and the lamp tube 300, thereby achieving quick cleaning of the outer wall of the high-voltage tubes 210 and the lamp tube 300 of the mosquito-killing lamp.

The present application provides a quick cleaning structure, which includes a sliding cleaning member 220 sliding along the high-voltage tubes 210 driven by an external force. The sliding cleaning member 220 is provided with sliding through-holes 221 in contact with an outer wall of the high-voltage tubes 210, so that mosquito bodies and the like adhered on the outer wall of the high-voltage tubes 210 are cleared, thus a mosquito-killing lamp applying the quick cleaning structure possesses a function of quickly and easily cleaning the debris, and the effect of the mosquito-killing lamp is guaranteed, together with a longer service life.

The technical principles of the present application have been described above in combination with specific embodiments. These descriptions are merely intended to explain the principles of the present application and are not to be construed as limiting the scope of protection of the application. Based on the explanation herein, those skilled in the art can associate other embodiments of the present application without any inventive effort, and all of them fall within the scope of protection of the present application.

What is claimed is:

1. A quick cleaning structure comprising,
a lamp holder; and
a high-voltage support,
wherein the high-voltage support comprises a sliding cleaning member and a plurality of high-voltage tubes, the sliding cleaning member is provided with a plurality of sliding through-holes, the plurality of high-voltage tubes are disposed in parallel with each other between a bottom part and a top part of the lamp holder, each of the high-voltage tubes passes through the sliding through-hole provided at a corresponding position, and at least one end of each of the high-voltage tubes is mounted and fixed to the lamp holder, the sliding cleaning member is slidable along an outer wall of the high-voltage tubes under an external force.

2. The quick cleaning structure of claim 1, wherein a shape of the sliding through-holes is the same as a shape of an outline of the outer wall of the high-voltage tubes, and each of the sliding through-holes is provided with an annular recessed portion on an upper surface side of the sliding cleaning member.

3. The quick cleaning structure of claim 1, wherein the plurality of high-voltage tubes are arranged in a ring shape at equal spacing, the sliding through-holes are annularly distributed on the sliding cleaning member, each of the sliding through-holes is respectively sleeved on the outer wall of the high-voltage tubes at a corresponding position.

4. The quick cleaning structure of claim 1, wherein the high-voltage support further comprises a pull rod provided with a travel limiting portion, the bottom part or the top part of the lamp holder is provided with a drawing sliding hole, the pull rod is arranged in parallel with the high-voltage tubes, an end of the pull rod is connected to the sliding cleaning member, the other end extends outside the lamp holder through the drawing sliding hole, the travel limiting portion is stopped at the drawing sliding hole and is limited at an inside of the lamp holder.

5. The quick cleaning structure of claim 4, wherein an end of the pull rod is provided with a flexible snap portion, the sliding cleaning member is provided with a snap ring portion engagable with the flexible snap portion, the flexible snap portion passes through the snap ring portion and is engaged with the snap ring portion.

6. The quick cleaning structure of claim 5, wherein the number of the pull rod is at least two, the number of the snap ring portion is equal to the number of the pull rod, a plurality of the snap ring portions are disposed symmetrically with respect to a geometric center of the sliding cleaning member, an end of each of a plurality of the pull rods is connected and fixed to an operating portion outside the lamp holder.

7. The quick cleaning structure of claim 4, wherein the high-voltage support further comprises a fixing member made of an insulating material, an end of each of the plurality of high-voltage tubes is fixed to the lamp holder, and the other end is fixed to the fixing member.

8. A mosquito-killing lamp applying the quick cleaning structure of claim 1 comprising,
the quick cleaning structure;
a circuit board; and
a lamp tube,
wherein the circuit board is disposed on the lamp holder and is electrically connected to both the high-voltage tubes and the lamp tube, at least one end of the lamp tube is fixedly mounted to the lamp holder, the lamp tube is disposed in parallel with the high-voltage tubes and is located inside the high-voltage support.

9. The quick cleaning structure of claim 8, wherein a central part of the sliding cleaning member is provided with a central cleaning hole, and the central cleaning hole is sleeved on an outer wall of the lamp tube and slides along the outer wall of the lamp tube, an annular surface of the central cleaning hole in contact with the outer wall of the lamp tube is provided with a rubber layer.

10. The quick cleaning structure of claim 9, wherein a protective net cover is arranged on the lamp holder, the protective net cover has a hollow mesh region, and the protective net cover covers the high-voltage support.
